(19) United States
(12) Patent Application Publication
(10) Pub. No.: US 2008/0314968 A1
(43) Pub. Date: Dec. 25, 2008

(54) System and Method for Capturing and Managing Personal Documents and Information

(76) Inventor: Patrick R. Maher, Dunmore, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/126,555

(22) Filed: May 23, 2008

Related U.S. Application Data
(60) Provisional application No. 60/939,707, filed on May 23, 2007.
(60) Provisional application No. 61/049,918, filed on May 2, 2008.

(51) Int. Cl. G06F 17/00

(52) U.S. Cl. 235/375

(57) ABSTRACT

A system and method for electronically registering individuals in a entity such as a school district is disclosed. The disclosed system provides the entity with the ability to provide each potential registrant with an account. The system includes hardware and software for receiving documents and information directly from the registrant and for storing same for later access. Methods and systems for allowing an individual to create and modify documents and forms used by the system are also disclosed. Additionally, the electronic registration system provides methods and systems for verifying the authenticity of information within a user's account.

### REFERENCE TO PRIOR APPLICATION

This application claims the benefit of U.S. Provisional Application No. 60/939,707, filed May 23, 2007 and U.S. Provisional Application No. 61/049,918, filed May 2, 2008.

### FIELD OF THE INVENTION

This invention relates in general to systems for capturing and storing personal information and documents that are required in connection registering, hiring, or enrolling an individual, and in particular to a computer-based system for capturing, storing, and disseminating such information in electronic form. The invention also relates to techniques for electronically registering individuals, for creating and modifying system documents and forms, and for securing the authenticity of documents and information used in the system.

### BACKGROUND OF THE INVENTION

School districts regularly maintain detailed records on every student from the time they are enrolled or transfer into a school in the district. Active record keeping continues throughout the student's attendance until the student either graduates or leaves the district by transfer or withdrawal. Although record retention policies vary from state to state, the usual practice is to retain all records indefinitely. It is estimated that about 90% of student records are stored in paper form. By maintaining student records indefinitely, school districts are expending substantial financial resources and facilities for storing paper records that could be purged on a regular schedule, as permitted by state or federal regulations.

The student registration process involves numerous student forms that are mandated by state and federal laws. Additionally, each district may create forms that are tailored for their specific information requirements. The Individualized Education Program (IEP) for children classified with special needs, requires several supplementary forms and records. In view of the ever-changing requirements for basic education and new classifications of students, it is possible for a school district to have 20% of its enrolled population classified as special needs and requiring an IEP. The special education departments of school districts are heavily monitored by state agencies for compliance with regulations. The failure to maintain adequate documentary records and to follow the agreed-upon IEP for a student can result in litigation and possible penalties for the school district. In many states student registration and IEP processing are handled by different individuals and departments. That situation creates undesirable opportunities for duplication and possible reporting errors.

The student registration and documentation processes described above are currently paper intensive functions. It is estimated that a typical school district could have at least fifty forms to choose from and maintain. The IEP process could have a comparable number of its own. There are also other documents, including letters, notes, tests scores, etc. that are included in a student's file during their enrollment in a school district.

The documentation capture, storage, and management problems associated with student enrollment at the primary education level are also present in secondary education institutions. Similar problems are encountered in connection with employee records in businesses and with medical records in hospitals and physicians' offices. Moreover, the more recent government requirements relating to privacy and security of personnel records adds another dimension to the problem of setting up and maintaining personnel records.

The storage and collection of participant files is a necessary but often expensive and time-consuming process for many companies, medical facilities, schools, governments, partnerships, organizations, and other entities (collectively, “facilities”). Personnel files may include a user's personal information, credit information, emergency contacts, insurance information, benefits, compensation, business calendars, etc. Traditionally, this information was stored by providing a user with a plurality of paper forms. These forms were filled out, signed, and then stored in a filing cabinet. With the advent of computers and digital storage devices, facilities could avoid storing large quantities of papers by hiring data-entry laborers to key in the data from the forms into an electronic database or to scan documents into electronic form and key in other data. Although this saves on storage costs, the practices are prone to typographical errors and transposition, and are slow and expensive to implement.

It would be more efficient to have students, employees, officers, customers, or patients (collectively “users”) directly enter the data into the database electronically, but providing a system that can accomplish this task has remained a long-felt need in the industry for a number of reasons. First, each facility would likely require their own custom-designed software to provide fields and labels for the forms. Custom-designed software is expensive, time-consuming to generate, prone to development and programming errors, and often incompatible with other software packages. Second, electronically storing forms may expose a facility to claims made by users that a form, document, or data field was changed by the facility or a third party. This is a concern for both the user and the facility. Providing systems, methods, and software that can maintain the integrity of the information and its privacy, while providing an easy-to-use interface that requires minimal technical skill to operate is a major goal of the present invention.

### SUMMARY OF THE INVENTION

In accordance with a first aspect of the present invention, there is provided a system for capturing and managing personal documents and information. The system includes a first computer that is programmed to receive information about an individual, a scanner operatively connected to the first computer for scanning a hard copy of a document into the computer, and an electronic imaging device operatively connected to the first computer and adapted for obtaining an electronic image of a characteristic of the individual and uploading same to the computer. The system according to this invention also includes a second computer that is programmed for creating a fillable electronic document to permit the entry of information about the individual and display means associated with the first computer for displaying the fillable electronic form. A document management means running on the second computer receives information, documents, and images from the first computer and creates and maintains an electronic folder for the information. The system further includes storage means for storing the electronic folder containing the fillable electronic document, the scanned document, and the electronic image of the individual, a database for obtaining and organizing searchable information obtained from said electronic folder, and an information retrieval means adapted for searching for information in the database for identifying an electronic folder of an individual, identifying an electronic document in the electronic folder, and providing the received information or the received electronic document to a requester.

In accordance with a second aspect of the present invention there is provided a system for capturing and managing documents that includes a computer, means for converting a paper document into electronic form, and means for entering data into said computer. The system also includes means for storing documents in the computer and means for displaying indicia relating to the forms and documents stored in the computer and the entered data in human perceivable form. The computer is programmed to display interactive user interfaces for permitting a user to create, modify, or display forms stored in said computer.

In accordance with a further aspect of the present invention, there is provided a system for capturing and managing documents that includes a computer, means for converting a paper document into electronic form, and means for entering data into said computer. The system also includes means for storing documents in a computer and means for securing the authenticity and content of a document stored that is stored in the computer.

### BRIEF DESCRIPTION OF THE DRAWINGS

The foregoing summary, as well as the following detailed description will be better understood when read with reference to the drawings, wherein:

FIG. 1 is a schematic block diagram showing the organization of the functional components of a system according to the present invention;

FIG. 2 is a schematic diagram of an embodiment of a system according to the present invention;

FIG. 3 is a schematic representation of an embodiment of a login screen display used in a system according to the present invention;

FIG. 4 is a schematic representation of an embodiment of a home screen display used in a system according to the present invention;

FIG. 5 is a schematic representation of an embodiment of a home screen display for a student user;

FIG. 6 is a schematic representation of an embodiment of a screen display used to modify forms or documents in a system according to the present invention;

FIG. 7 is a schematic representation of an embodiment of a screen display used to create or modify an emergency contact form;

FIG. 8 is a schematic representation of an embodiment of a screen display used to add forms, scans, and documents;

FIG. 9 is a schematic representation of an embodiment of a screen display used to access all forms, scans, and documents available in a user's account;

FIG. 10 is a schematic representation of an example a screen display of a filled-in student residence information form;

FIG. 11 is a schematic representation of an embodiment of a screen display used to access student information;

FIG. 12 is a schematic representation of an embodiment of a screen display used for accessing options available to a system administrator;

FIG. 13 is an example of student information form screen display before it has been customized; and

FIG. 14 is an example of the student information form screen display that has been customized.

### DETAILED DESCRIPTION

A system according to the present invention will now be described with reference to the drawing figures. FIG. 1 is a schematic block diagram that shows the functional organization of a system according to this invention. The system 10 generally includes an information intake device 12 which may be embodied as a general purpose computer, such as a personal computer, or as a special purpose computer, such as a kiosk or dedicated terminal. The information intake device 12 is adapted to display electronic forms to a user, which forms can be filled in on-line with information about a person for whom a document folder is to be created. The information intake device 12 has a graphical user interface that permits a user to easily navigate between and within the electronic forms and proceed with the input of information. The intake device 12 is adapted to automatically fill in information from one form that is needed in another form, to speed up the information intake process. The electronic forms used in the information intake apparatus can be generated by any known computer software, such as the PUREEDGE electronic form software.

The system 10 also includes a document preparation module 14 which receives the completed electronic forms from the information intake module 12. A hard document input device 16 is connected to the document preparation module 14 for converting a hard copy of a document into electronic form and providing an electronic image file of the document. Among the types of documents that would typically be uploaded to the document preparation module 14 would be a birth certificate, a driver's license, paper medical records, and documents relating to previous employment or relating to a previously attended school. An imaging device 22 is also connected to the document preparation module 14. The imaging device 22 is used to capture an image that is characteristic of the person for whom the file is being created. Among the types of images contemplated would be a photograph of the person and an electronic copy of his/her signature. The captured image(s) are provided to the document preparation module 14.

The document preparation module 14 receives the text, document, and image files from the information intake device 12, the hard document input device 16, and the imaging device 22, respectively, and generates an electronic folder which contains all of the captured information, documents, and images associate with the person who is being registered. A preferred document management program for use in generating and maintaining the electronic document folders is the DOCUSHARE software sold by Xerox Corporation. One document preparation module 22 is also adapted to secure the electronic folder against unauthorized access so that the highly personal data in the electronic folder cannot be altered or stolen. The security feature also permits an entity to provide a certified copy of a document in the electronic folder because the authenticity of the document is more reliably assured.

A document storage device 20 is provided in the system 10 for receiving and storing the electronic folder created for the new person. The document storage device 20 is designed to have storage capacity sufficient to store several years of documents in electronic form. A database module 18 is connected to the document preparation module 14 for obtaining searchable information from the electronic personnel files generated by the document preparation module 14. The database module 18 creates and stores a searchable database of persons whose records have been registered and stored on the document storage device 20 by an authorized user of the system. The database would include information that identifies an individual having an electronic folder in the system and indicia of the nature of the documents and images that can be retrieved from the system. In this way, a user of the system can readily access some or all of the personnel records of an individual, including obtaining electronic copies of documents in the individual's electronic folder.

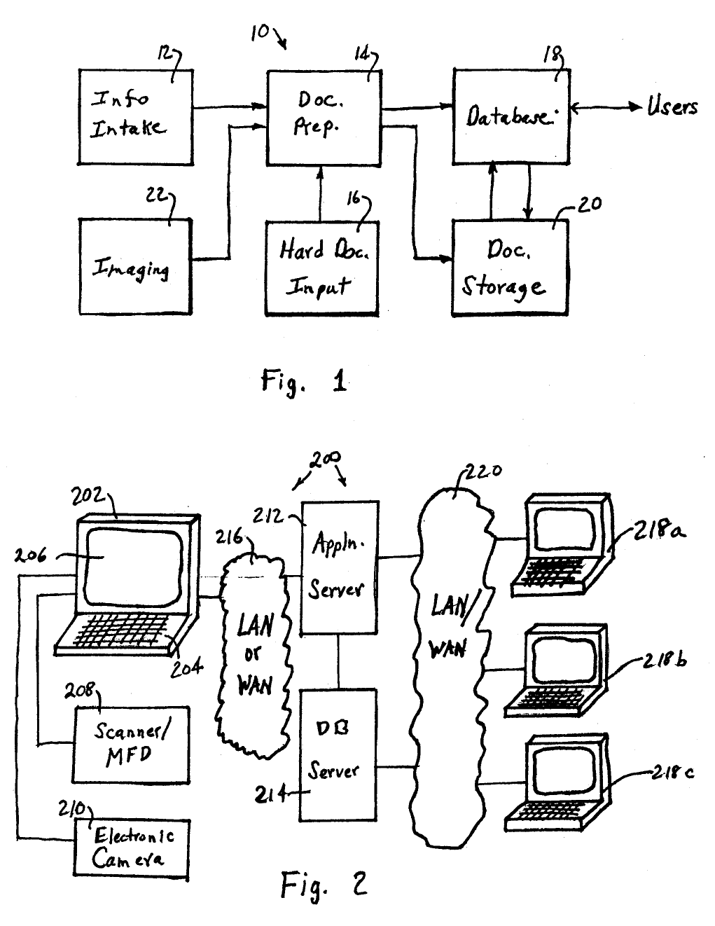

Referring now to FIG. 2, there is shown schematically an embodiment of a system according to the present invention. The system 200 includes a terminal 202 for entering information about the person to be registered or employed. The terminal 202 has a keyboard 204 and a display screen 206. The electronic forms required for registration are displayed on the display screen 206 and the registrant or prospective employee fills out the electronic forms by entering required information via the keyboard 204. A scanner 208, or a multi-function device, is connected to the terminal 202 so that electronic copies of hard documents such as birth records, medical records, etc. can be input to the system as required. An electronic camera 210 is also connected to the terminal 202 for capturing an image of the registrant or prospective employee for the file. Optionally, a signature pad (not shown) can be connected to the terminal 202 for capturing an electronic image of the registrant's signature, and if needed, the submitter's signature.

The electronic documents and images provided to the terminal 202 are uploaded to an application server 212. The application server 212 is programmed to run various applications needed for implementation of the system. In particular, server 212 would be running the electronic form preparation software for creating the electronic forms that are used on the information intake terminal 202. The server 212 also runs the document management software that creates and manages the electronic folders associated with each registrant or employee. A second or database server 214 is provided which runs the database management software. The database server is connected to the application server 212 for obtaining the searchable information from the available electronic personnel files. A mass storage device (not shown) is also provided for long term storage of the electronic folders and files associated with each registered individual.

The electronic documents and other information stored by the system and available from the database server 214 are accessible by a plurality of remote terminals 218a, 218b, and 218c, for example. In general, the remote terminals are located in facilities that are remote from the information intake and storage sites. In the context of a school district information system, the remote terminals 218a-218c would be located, for example, in a school superintendent's office, a school principal's office, or a teacher's office. In the context of a business entity, the remote terminals would be located, for example, in an executive's office or a manager's office. The remote terminals 218a-218c may be general purpose computers that run a client software application which permits access to the database, documents, and other information in the system. Alternatively, the remote terminals could be configured as dedicated terminals. The remote terminals are used to access information about an individual available in the system and retrieve documents from the electronic folder of the individual.

It will be appreciated that the system according to the present invention is useful not only for the initial intake of information and documentation of registrants, but also subsequent augmentation of the registrant's file. The remote terminals 218a-218c can be used to enter additional information. For example, electronic forms relating to performance evaluations, special needs assessments and implementations, acknowledgements, and any other documentation and information that relate to a student's or employee's record, can be added by authorized administrative or management personnel. In addition, a scanner and/or multi-function device (not shown) can be associated with a remote terminal, for example, terminal 218a, for inputting electronic copies of hard documents to an individual's electronic folder.

The application server 212, database server 214, and mass storage device may be located in the same facility as the information intake terminal 202 and the remote access terminals 218a-218c. The servers and the terminals preferably communicate through a local area network 216, 220. It is also contemplated that the application and database services and the electronic storage functions can be hosted at a remote location by a third-party service provider. In such case, the communication of documents and information between the intake terminal 202 and the servers 212, 214 and between the remote access terminals 218a-218c and the servers would take place over a wide area network such as the internet.

The present invention may be embodied as a software system provided on a disc or in a downloadable form. Alternatively, the system can be provided as a subscription service. In either case, the software ordinarily must be executed by a microprocessor to work. A general purpose computer comprising basic elements such as a memory, network interface, microprocessor, and hard drive may be provided to run the software, but other hardware configurations are possible. When a facility or a user wishes to run the electronic registration software, often it will do so from a separate computer which may be remote from the main office of the entity using the system. Hereinafter, this separate computer will be referred to as a client and the computer running the software will be called the server. The computers themselves may have the same or different components. In some implementations, the software may be produced as a website, wherein the client will navigate to the webpage of the server and allow the user to interface with the software via a web-browser. In other implementations the software may be implemented as software installed on the client. Implementations that use both a web-browser and user-installed software are also contemplated. For example, a client may need to install and use an ActiveX control, interpret a java script, or execute a program to use the software.

The server may host a master website (such as “www.electronic_registration.com”) that a user can navigate when using a client computer. This master website may comprise a number of extension sites such as: “www.school1.electronic_registration.com” or “www.electronic_registration.com/school1.com.” A user entering the master website may navigate using links or prompts to the appropriate extension site or the user may type the full name into his or her browser. As is known in the art, a dynamic website that requests data from the client to customize the page as appropriate for the particular client may be implemented. The master website may not need to change the address of the page currently being viewed by the client, if it changes the contents of the page being displayed for the particular client. Additionally, the master website may simply provide a user-interactive applet or program which provides the user with the ability to enter or view information.

To use the software, a user will navigate to a facility's website. There, the user may be presented with a number of options, which may be implemented as links, buttons, menus, etc. Selecting one of these options will vary the information being shown on the client's browser or interface. For example, in one embodiment of the present invention for a school registration system, a user can select buttons labeled “First time user”; “Student”; “Teacher”; “Parent”; “Faculty”; or “Administrator.” See FIG. 1A. More or fewer options can be provided. As another example, a hospital may have buttons labeled, “First time user”; “Patient”; “Family”; “Doctor”; “Nurse”; “Faculty”; “Legal”; or “Webmaster.” These options can be supplemented or decremented depending on the needs of the particular facility. Particular options may have further sub-options. For example, “Doctor” may have “hematology” or “rheumatology” as sub-options. These sub-options may have different layouts or forms as may be desired for the particular facility.

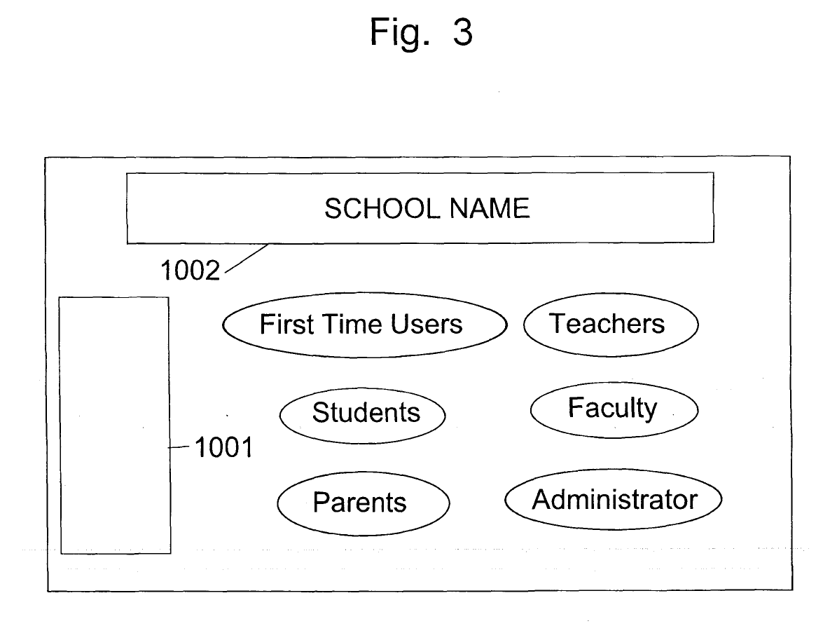

Also shown in FIG. 3 is a location for banner advertisements, 1001 and 1002. Either banner could also be used to describe the particular facility or display any other desired information such as a school name. The banner advertisements may be used to help decrease the cost to the user and/or the facility.

A facility, such as a high school, interested in purchasing a software license to a system according to the present invention, may purchase the license from an approved and authorized reseller. When the license is purchased, the software company may create a website for the school using one or more templates. The software may include a specialized school template to simplify the designing of school registration web pages. Either the facility or the software company may then customize the default facility website through the use of specialized tools or a wizard or both.

The screen display shown in FIG. 3 has six buttons, “First Time Users”; “Student”; “Teacher”; “Parents”; “Faculty”; and “Administrator.” Clicking on the “First Time Users” button may initiate the registration process for the registration of all users. Logging into the system as an administrator may allow an administrator to make modifications to the layout, forms, labels, warnings, look and feel, and a variety of other options. The “Teachers”; “Students”; “Faculty”; or “Parents” buttons may have some overlapping features such as allowing the respective user to modify, supplement, or access registration information. In many applications though, the options, forms, and design of the website for these users may be different. Though the following disclosure will discuss in detail many of the capabilities for a student, it should be remembered that similar functionality could be added for administrators, teachers, and parents. The reason one may wish to add these groups even though they may have some similar functionality is that these groups may have some important differences such as the ability to view pay checks (administrators and teachers), submit homework (students), or pay a tuition bill (parents). Also, the administrator could customize the particular advertisements to a particular user group, and can also customize the interface as may be appropriate for the particular age, preferences, or sophistication of the user.

### 1. Modifying, Supplementing, and Viewing Registration Data

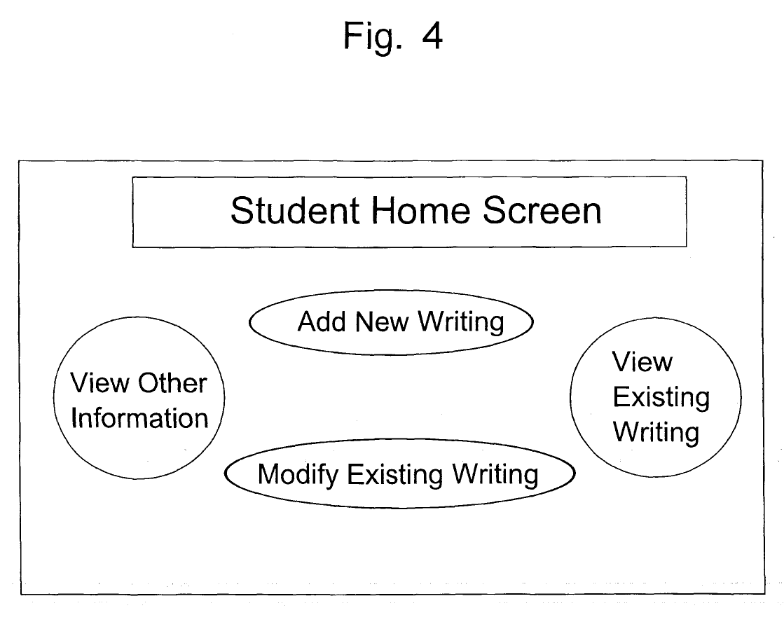

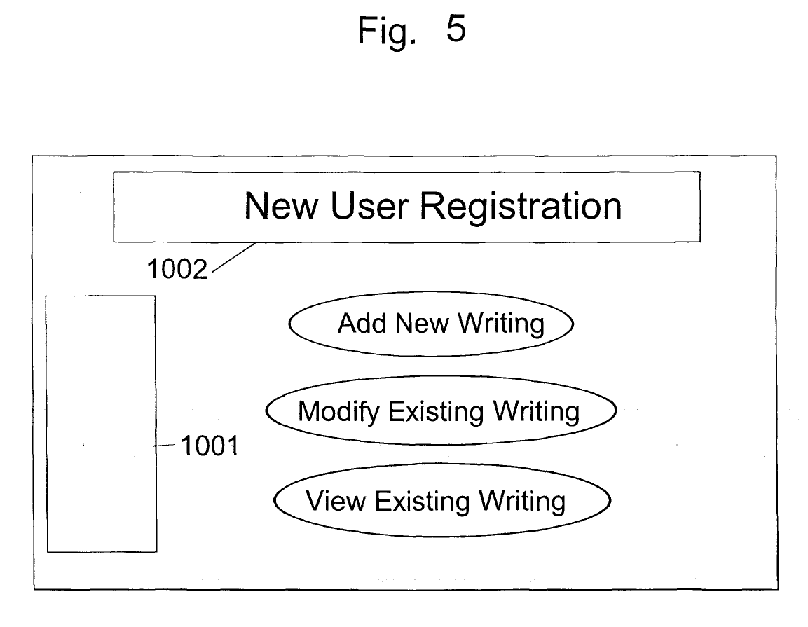

The electronic registration software provides the user (student, teacher, administrator, faculty, parent, etc.) with efficient ways to register with a facility. For example, in the context of an educational institution, it is contemplated that the system could be set up to provide a student with the ability to perform tasks such as retrieving grades, homework assignments, or classroom materials, or accessing school email, registering for courses, etc. In some cases, the student may need to have a user name and password, a secret question, site key, or digital certificate to enter the student site. The electronic registration system provides a student with the ability to modify existing forms and documents, add new forms or documents to his or her account, and to view existing forms in his or her account, FIG. 4. Other types of users of the system according to this invention, e.g., doctors at a hospital, associates in a law firm, etc., would be able to create similar types of accounts, but relating to their particular information needs. Entered data is retained immediately upon its input.

### A. Modifying a Form

The modify function allows a student to modify the forms, scans or documents associated with his or her account. A user's account will comprise various types of writings. A writing includes information written by hand, by computer, printed by a printer or any other mechanism. A writing may be printed on paper, etched in stone, saved electronically as a file or an image, or expressed by any other known convention. There a four types of writings: conventional writings, forms, scans, and documents. Conventional writings are writings like newspapers or textbooks that cannot be readily accessed by a computer without an input device. A scan is an image of a writing such as picture, graphic, convention writing, form, or document. A form is a writing which contains fields and labels. A document is a writing saved in a native or universal format such MSWord, HTML, or text.

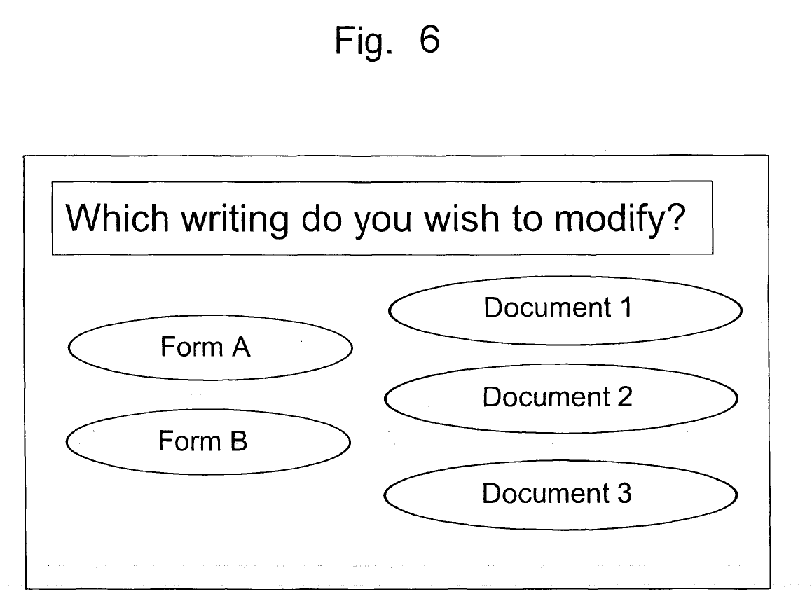

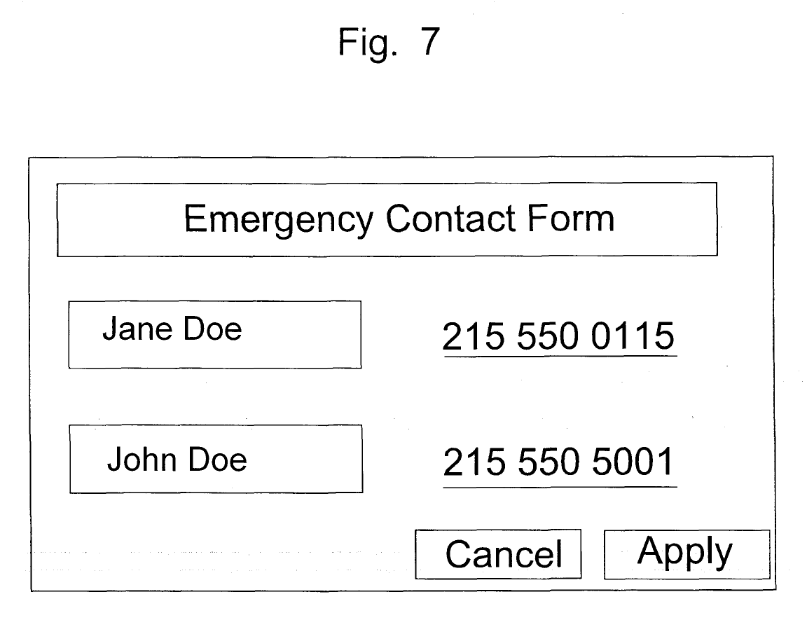

When a user clicks on the button “Modify Existing Writing” as shown in FIG. 4, the software will ask the user which writing the user wishes to modify. As in FIG. 6, the software presents the user with two forms and three documents, which he or she can modify. If the user clicks on “Form A”, which is an emergency contact form in this example, a new screen will be displayed as shown in FIG. 7. The form shown in FIG. 7 is auto-filled using the pre-existing data from the user's account. Auto-filling is an important feature in many of the embodiments of present invention because it reduces the amount of time a user needs to spend when entering data. The auto fill feature also improves the accuracy of the data entered. Nonetheless, the auto-fill feature is optional because the invention can be practiced without auto-filling.

To modify the form, the user clicks on the phone number field (which is a hyperlink in this example) of the second listed contact (John Doe). The student or user changes the number and selects the apply button on the right. The user could also click the cancel button to cancel the modification process. Clicking the apply button causes the client to send a transmission to the server to change this information. This updates the information on the server, changing the information in the student's account.

### B. Adding a New Form or Document

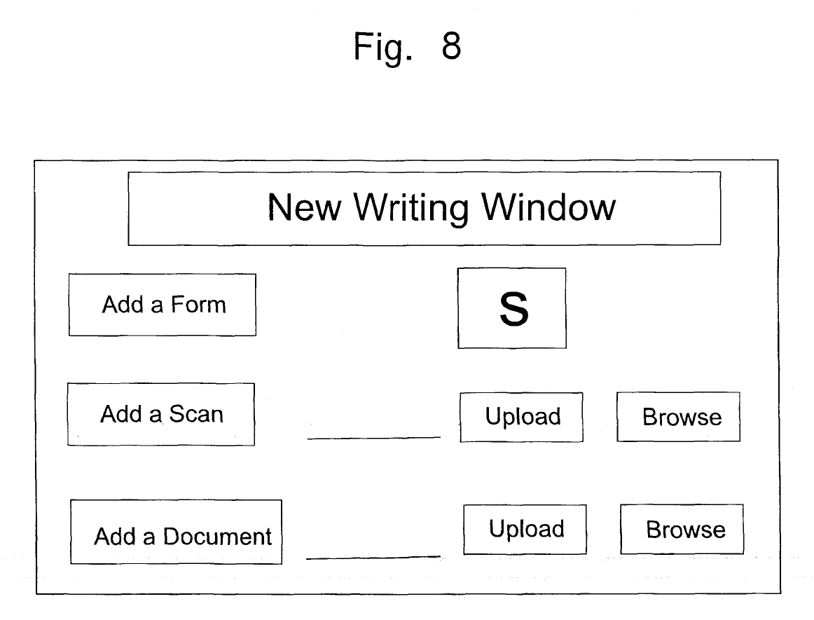

A facility such as a school or school district, may occasionally need additional forms, scans, or documents to be submitted. For example, a student may be going on a field trip in which a permission slip might be required. The registration system according to this invention may call or email the student or the student's parent to tell him or her that there is an outstanding writing that needs to be submitted. When the student (or parent) logs into the system remotely, the system displays a notice that the new writing is needed. In the present example, the student would click on the “Add New Writing” button, shown in FIG. 4. When that button is clicked, the system checks the system database and provides the user with a list of all the writings he or she can add. The system may also present the user with the ability to upload a form, scan, or a document to the system as shown in FIG. 8. To upload a new scan, a student may type or browse to the directory of the scan saved on his or her client computer. The student would then click on the upload button which sends the scan to the server.

To perform the upload procedure, the user would need to have a scanned copy of the signed permission slip saved on the client computer. Obtaining the scan can be done by using a conventional scanner or digital camera. Additionally, the user could use a deluxe scanner which may be provided at the facility. A deluxe scanner may have features like a built-in display system with optional touch screens, keypads, and key cards to allow the user to more easily enter data. The procedure for using a deluxe scanner may comprise the following sequence of steps. The user in this example takes his signed permission slip to the deluxe scanner. The user provides a user name and password to the scanner. Alternatively, the user could provide an RFID transponder, fingerprint, or a bar code on the user's ID card as proof of identity to the system. The scanner recognizes the user, and displays the “student home screen,” such as the screen shown in FIG. 4. The student home screen provides the student with available options he or she can utilize to make changes to or view information pertaining to his or her account. The student then may click the “Add New Writing” button. The system then displays a screen such as that shown in FIG. 8. This screen provides the user with options for selecting a source for the document, scan, or form. By clicking on the scanner icon, which is illustrated as a capital letter “S”, a scanner dialog box (not shown) is opened. The scanner dialog box includes settings and options for scanning a document in printed form. The scanner dialog box gives instructions to the student to place the writing (in this case the permission slip) on the scanning glass or document feeder, and click the “Start” button. The scanner scans the writing and displays the scanned image for the student on a monitor or viewing screen. The student then verifies that the document was scanned correctly. The student clicks submit, which uploads the form to the server. The server or scanner may run an OCR program on the scan, and the server may change an internal setting showing that a permission slip was submitted. The server may request the student to confirm the scan is signed by a parent, that it was dated, etc. The student may then be prompted to exit the system or access a different option. The student in this example may have some additional tasks to perform. For example, if the student is new to the school, the student may want to verify that his home address is correct, or the student may want to check his attendance records, or the student wants to see his homework for his English class. Following is a description of the procedures according to this invention for performing such tasks.

### C. Accessing Records

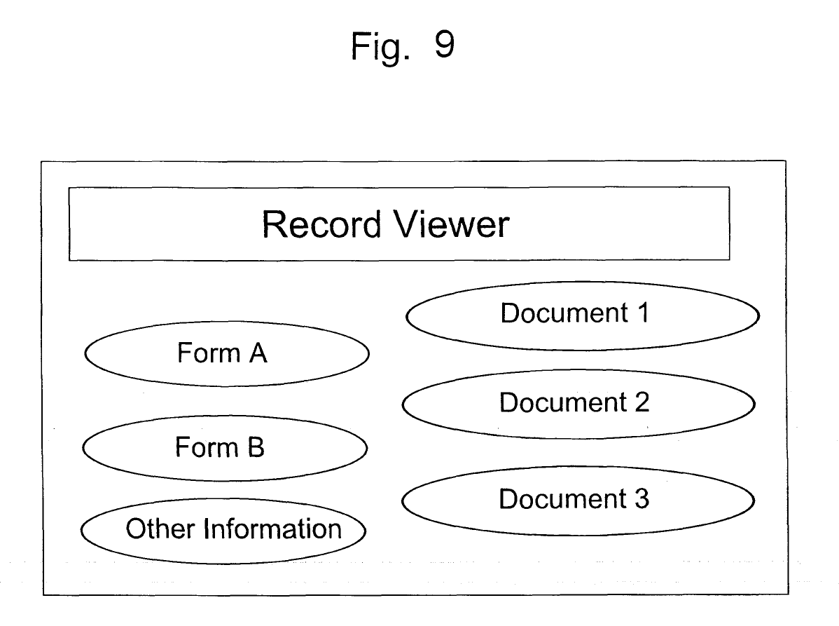

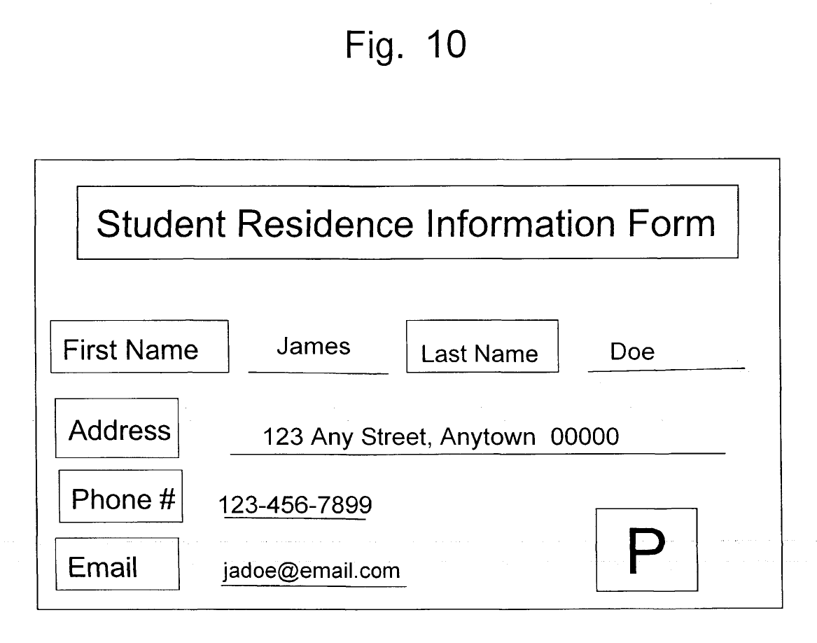

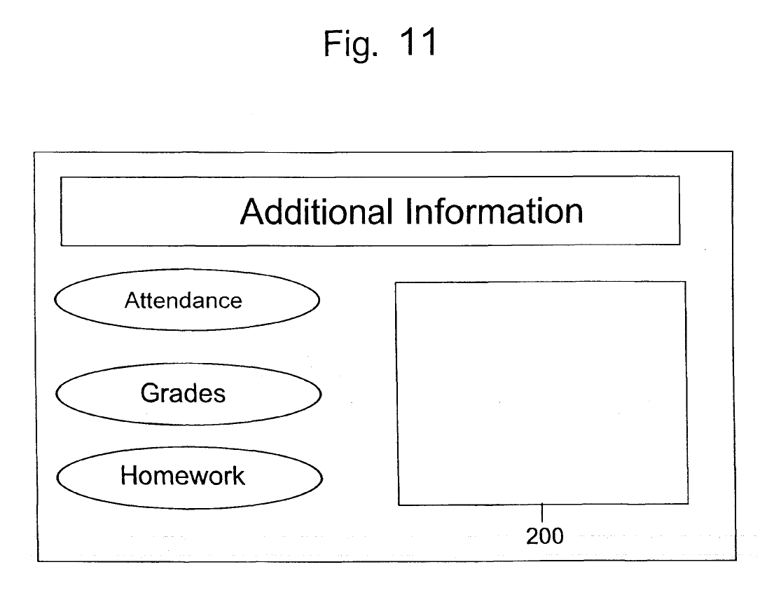

Starting from the student home screen shown in FIG. 4, the student clicks on the option to view or access his records (“View Existing Writing”). Clicking this option generates a screen display as shown in FIG. 9 that shows the student available information relating to the student's account. The student clicks on the area entitled “Form B” which is a student residence information form, which brings up the form showing his home residence information, as shown in FIG. 10. The student may notice, for example that the zip code is incorrect. The software may provide a button to allow the student to change the data, which would allow the fields in the form to be edited. However, the student, in this example, is not sure what the right zip code is. He decides to print a blank student residence information form by using the print option, shown as a capital letter “P”. Optionally, the student could also print the form partially filled in with the correct data. The deluxe scanner (or the student's printer if accessing the system from home) prints the form. The student then fills the form out by hand, and decides to fax it to the school. The school receives the fax, scans it, uploads into the electronic registration system, and the system replaces the old student residence information form with the new scan of the new student residence information form. The registration software may invite the student to type in the information for the scanned document next time the student logs into the system or may assign a data entry specialist from the school to type in the information.

### D. Accessing Other Information

The system may also provide the student the ability to access other information such as his attendance records or show him a copy of his assignments. This option may be accessed by clicking on the “Other Information” button on the record viewing selection screen shown in FIG. 9. The software would then display a screen as shown in FIG. 2G that provides the student with additional information relating to his account. For example, to check attendance records, the student may click on a button entitled “Attendance”, which causes display window 200 to show the number of times the student has been marked late, present, and absent.

### 2. Customizing the Software and Forms

Another important feature of the system according to this invention is that the system may provide an administrator with the ability to customize the interfaces of other system users. The capabilities the administrator can be broken-down into several categories: 1) the administrator can add forms; 2) modify forms; 3) change the colors, organization, layout of the website; 4) change security settings; and 5) change options or capabilities of the other users. In prior art systems, much of this type of functionality was hard-coded into the software, which meant that changes often required the intervention by a programmer. The system according to the present invention provides an alternative to the hard-coding solution.

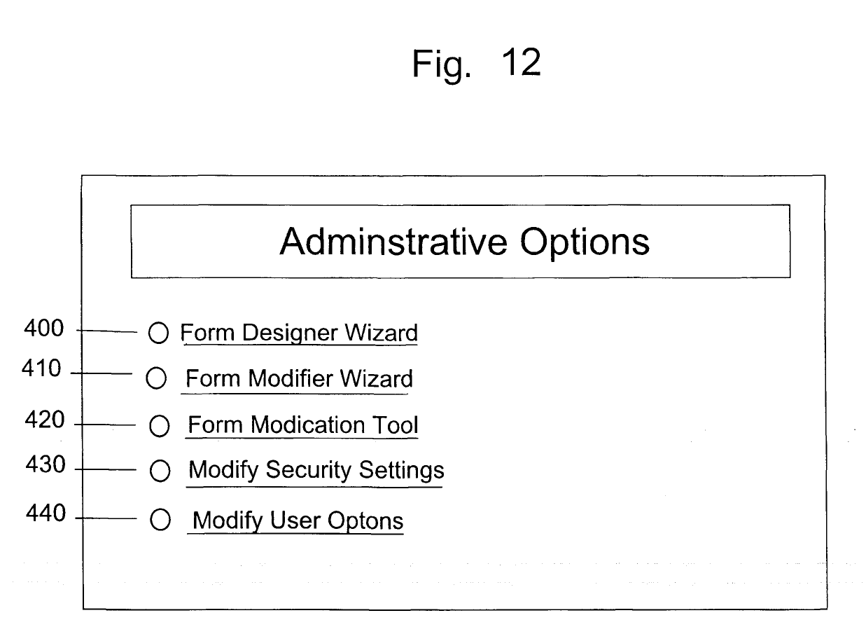

The system provides an Administrator Options Screen as shown in FIG. 12. From the Administrator Options Screen, the administrator logs into the administrator account. The administrator is then presented with five selection options. The screen display embodiment shown in FIG. 12 represents the selection options as radio buttons, but other configurations are possible. Clicking on button 400 permits the administrator to add a new form by causing the system to run a Form Designer Wizard program. Clicking on button 410 permits the administrator to modify an existing form by causing the Form Modifier Wizard program to run. Additionally, the administrator may be able to run a Form Modification Tool to create or modify the forms without or in addition to using the appropriate wizard.

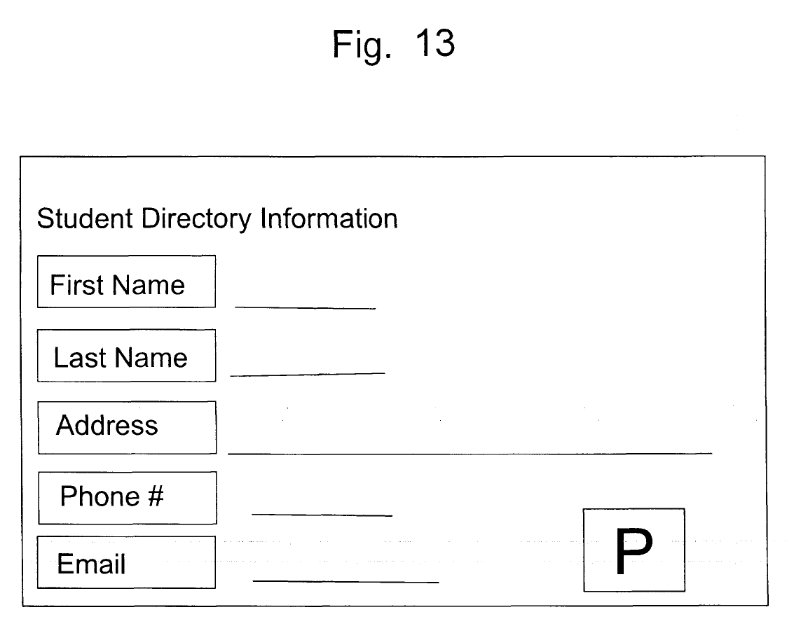

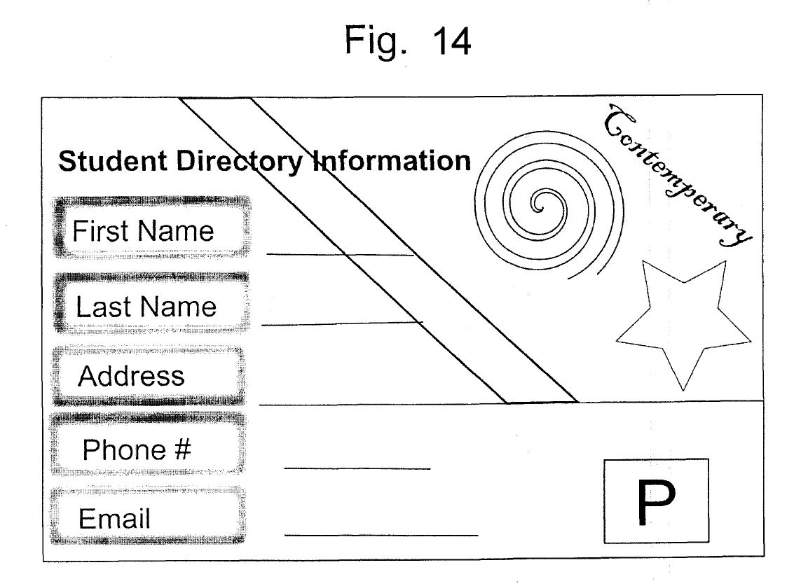

By way of example, it will be assumed that the administrator clicks on button 400, which opens the Form Designer Wizard. The form designer program proceeds to ask the administrator basic questions about what information should be included in the new form. Forms may include fields, labels, instructions, validation rules, warnings, etc. Additionally, forms need to be positioned on the screen and given an overall design. The form designer program asks the administrator appropriate questions so that the program can automatically design the form. The following listing of questions and answers are presented to exemplify how a form design session could be used to generate a new form, such as that shown in FIG. 14. The original form (before it is customized) is shown in FIG. 13. While the format used below illustrates a question/answer form of interactive dialog, in many implementations other conventions may be used. For example, the software can provide a list of available answers to the question, which the user may select by clicking on an associated radio button or a hyperlink menu.

### Example Question and Answer Session of the Form Designer Wizard

In this example, questions (Q) are posed by the Wizard and answers (A) are provided by the administrator/user.
Q: What is the title of the form?
A: Student Directory Information.
Q: What is the label for the first field?
A: First Name.
Q: Would you like Last Name to be the second field?
A: Yes.
Q: What is the label for the third field?
A: Address.
Q. What is the label for the fourth field?
A. Phone number.
Q: What is the label for the fifth field?
A: Email address.
Q: What is the label for the sixth field?
A: No more fields.

From this dialog, the electronic registration system generates a form. FIG. 14 illustrates the form created by the above dialog. The wizard may show the form created and ask more specialized questions about acceptable terms or values that can be inserted in the fields of the form as illustrated by the following example questions and answers.
Q: Would you like to customize the form?
A: Yes.
Q: Would you like to customize a field?
A: Yes.
Q: Which field?
A: The first field.
Q: Would you like this field to be required?
A: Yes.
Q: Would you like this field to utilize an input mask?
A: No.
. . . (More questions and answers)
Q: Would you like to enter a size limitation?
A: No.
Q: Would you like to customize any other field?
A: No.

The foregoing question-and-answer dialog customizes the first name field to be a required field. Additional field requirements can be set using a dialog like the one above. After the fields are customized, the wizard can proceed to ask questions concerning the overall design of the form. This can be done individually or by using a theme or both. The following dialog illustrates using a theme to customize the form. The form is then more specifically customized by specifying the border of the field. Following is an example of a form customization question-and-answer dialog.
Q: Would you like to apply a theme?
A: Yes.
Q: Which theme would you like to use?
A: High School Contemporary Gray-scale.
Q: Would you like to customize this theme?
A: Yes.
Q: What do you wish to customize?
A: The borders.
Q: Which border should be used?
A: A shadow border.
Q: How thick should the border be?
A: Two pixels.
Q: What color should the border be?
A: Gray.
Q: Do you wish to change the default field padding?
A: No.
. . . (More questions and answers)
Q: Do you wish to customize any other feature of this theme?
A: Yes.
Q: Which feature?
A: The title of form.
Q: What would you like changed?
A: The font style.
Q: Which font style should the title have?
A: Bold.
Q: Would you like to make any other changes?
A: No.

The software may offer the user a set of choices to customize rather than asking open ended questions. For example, when the software asks, “What do wish to customize?”, the software may also display a list of possible answers. Such a list could include such items as borders, fonts, colors, layout, etc.

The user in the above example specified “gray” as the color for the borders and “shadow border” as the border style. In some cases, a user may not know what to type in response to a question. Similarly, providing a long list of colors (for example) may be a cumbersome way to present the information to the user. As an alternative to the Form Modification Wizard, the user may choose to modify an existing form by using the Form Modification Tool 420. The Form Modification Tool could include a color wheel to allow the user to select the exact color to be used for a particular form element (such as a border). The Form Modification Tool may also include a border selector tool which allows the user to select a border from a graphical list of available borders. Additionally, the Form Modification Tool may allow the user to stretch the border to a desired thickness.

In some embodiments, the Form Modification Tool may be accessible while using the Form Designer Wizard. This allows the user to answer a question posed by the Form Designer Wizard by using the Form Modification Tool 420. Selecting to use the Form Modification Tool 420 in the Administrative Options screen, allows a user to bypass the Form Designer Wizard, so that the user can modify the form using only the form modifying toolset.

In some cases, the facility running this software may wish to provide other users (as opposed to just the administrator) with the ability to customize the look, feel, or design of a system webpage. An administrator can decide to grant this functionality to a user, and can place restrictions where the administrator feels appropriate. For example, the administrator may allow the student to change the color of the backdrop of the webpage, but not to change the style of the text in labels of the forms. The software may also provide the administrator with the ability to require certain forms to be scanned or handed-in personally, or to prevent parents from seeing their child's grades, while providing this option to teachers and students.

### 3. Maintaining the Integrity of Forms and Documents

A fully-customizable, electronic registration system as described above will still be somewhat limited in its utility, if the system cannot adequately protect the integrity of the documents, scans, and data received from the forms. As discussed earlier, there are many ways to forge electronic information, and the utility of having a depository of electronic data may be diminished if the facility cannot prove this information is accurate and authentic.

The prior art way of proving that a form, scan, or document is authentic usually involved sending a copy of the writing to a designated third party each time a new writing was created or modified. This process is expensive, time consuming, and often leads to the inadvertent exposure of a company's confidential information. If a dispute arose between a user and a facility, the facility or user could prove the authenticity of the writing by obtaining a copy from the third party.

Rather than relying on a third party to provide this service, a facility can use an encryption string certification process according to the present invention. To protect the integrity of the received documents, scans, and form data, registration system of the present invention creates a unique signature (encryption string) based on certain details of the writings. Details such as bit size, creation, modification, and access dates, name, and file location are used to generate a character string. Once this character string is created, it can be stored on the computer or a remote computer, and used to prove that the original files were unmodified. Following is an example of the security encryption process for documents associated with a hypothetical student.

A folder for student James Doe contains two forms and one document.

### Form 1:

Has a file size of 26, 522 bytes;

Was Created Monday, Dec. 31, 2007, 1:05:32 PM;

Modified Jan. 7, 2008, 4:28:34 PM;

Accessed Jan. 8, 2008, 11:19:24 AM;

The file was stored in C:\data\James_Doe;

Is named Student_Registration.txt.

### Form 2:

Has a file size of 46, 527 bytes;

Was Created Monday, Dec. 11, 2005, 7:05:32 AM;

Modified Apr. 7, 2007, 6:28:34 PM;

Accessed Jan. 5, 2008, 1:19:24 AM;

The file was stored in C:\data\James_Doe;

Is named Emergency_Contacts.txt.

### Document A:

Has a file size of 552,462,235 bytes;

Was Created Wednesday, Mar. 19, 2001, 2:05:32 AM;

Modified Jun. 7, 2004, 6:18:30 PM;

Accessed May 3, 2006, 11:29:24 AM;

The file was stored in C:\data\James_Doe;

Is named Driver's_License.pdf.

A computer program that is part of the system reads these files and stores the above data in the memory of the computer. The computer takes each piece of data (collectively the input string) and runs an algorithm(s) on the data to generate an encryption string (output string). It may be preferable for the program to create a complex output string so that a would-be-hacker cannot easily determine the input data used to determine the encryption string. Thus, it may be useful to use a one-way function so that the output strings cannot be used to determine the input string. Additionally, a user may want to design a cipher or function that cannot be easily determined from either the input or output string. Additionally, it may also be preferable to minimize the likelihood that any two input strings when processed will resolve the same encryption string (output string).

An embodiment of a process for generating an encryption string for securing the documents in the foregoing example may have the following steps:

(1) The software loads the data from Forms 1 and 2 and from Document A into an array that may appear as follows:

| ID | Size | Created | Modified | Accessed | Location | File Name |
|---|---|---|---|---|---|---|
| Form 1 | 26,522 | 12/31/07 | 01/08/08 | 01/08/08 | C:\data\James | Student_Registration.txt |
| | | 1:05:32 PM | 4:28:34 PM | 11:19:24 AM | Doe | |
| Form 2 | 46,527 | 12/11/05 | 04/07/07 | 01/05/08 | C:\data\James | Emergency_Contacts.txt |
| | | 7:05:22 AM | 6:28:34 PM | 1:19:24 AM | Doe | |
| Form 3 | 552,462,235 | 03/19/01 | 06/07/04 | 05/03/06 | C:\data\James | Driver's_License.pdf |
| | | 2:05:32 AM | 6:18:30 PM | 11:29:24 AM | Doe | |

(2) A number of computations may be performed on the data above to generate an encryption string. In one embodiment the software is programmed to take the string in the 3^{rd} row, 2^{nd} column, and subtract 1500 and then square the difference. It saves the result as number M1. The system takes the string in the 2^{nd} row, 4^{th} column and converts the date and time into a number, 01070842834. The software then performs a natural logarithm on that number and saves the result as M2. The software then takes the string in the 2^{nd} row, 6^{th} column and concatenates it with the string in the 4^{th} row, 7^{th} column. The software takes the resulting string and scrambles the characters using a transliteration algorithm and saves the result as M3. The process would continue until a satisfactory amount of the data was used and converted into different strings. The software may then concatenate all the strings together to provide an encryption string. The encryption string may be further processed to more obscure the original input strings.

Encryption strings such as the one created above, may be useful for proving that the data is authentic or unmodified. For example, a controversy may arise about the content of a document that has been stored electronically in connection with the registration system according to this invention. One party may contend that information in the document was modified by the party that holds the document in electronic form. The party in possession of the electronic document can prove that the document has not been modified by using the encryption string technology.

To use this technology to prove the form is the same as it was when a user submitted it, the facility would generate a first encryption string using the form's data when the form is first submitted to them, time T₀. The facility may also send this string to a data entity to store the string for verification purposes. At a later time, (such as when the facility needs to prove the authenticity of the document) the facility reruns the encryption string generation process to generate a second encryption string. The facility compares the first and second strings to verify that the form has not been modified. The comparison may also be performed by the data entity. If the strings match, the form currently in the facility's database is the same as it was when the first encryption string was generated.

Similarly this process may be used to prove the files have been modified since a user created them. This may be useful in situations where the original form contained the correct information, but the present form does not.

A system according to the present invention provides a user-customizable electronic registration system that may be used with or without the data security techniques. The present invention may be used with technologies such as those featured in U.S. Pat. No. 5,781,629, entitled “Digital Document Authentication System”, the entirety of which is incorporated herein by reference, or U.S. Pat. No. 7,047,404, entitled, “Method And Apparatus For Self-authenticating Digital Records” the entirety of which is also incorporated herein by reference.

Though many of the embodiments described herein relate to an electronic registration system for a school, the described system may be used in any facility that can make use of an electronic registration system including corporations, hospitals, government agencies, and law firms. Additionally, the present invention is described with reference to particular screen displays, but various other interfaces could be added to or substituted for the ones shown and described herein. The specific systems, methods, and software described are exemplary only. It is contemplated that other configurations of the system according to this invention can be constructed and used.

1. (canceled)

2. (canceled)

3. (canceled)

4. A system for capturing and managing personal documents and information comprising:
an information intake apparatus configured for (i) displaying an information form, (ii) permitting a person to input requested information in the form of text into the displayed form, and (iii) providing the information as an electronic text file;
an imaging device for capturing an image that is characteristic of the person and providing said image as an electronic image file;
a hard document input device that is configured for scanning a printed document and converting it to an electronic document file; and
a document preparation apparatus operatively connected to said information intake apparatus, said imaging device, and said hard document input device for (i) receiving the electronic text file, the electronic image file, and the electronic document file, (ii) providing an electronic folder containing the electronic data file, the electronic image file, and the electronic document file, and (iii) providing searchable indicia associated with the electronic folder.

5. A system as set forth in claim 4 comprising a storage device operatively connected to said document preparation apparatus for receiving and storing the electronic folder.

6. A system as set forth in claim 4 comprising a database storage device operatively connected to said document preparation apparatus for receiving the searchable indicia associated with the electronic folder and storing the searchable indicia in a database stored on the database storage device.

7. A system as set forth in claim 5 comprising a database storage device operatively connected to said document preparation apparatus for receiving the searchable indicia associated with the electronic folder and storing the searchable indicia in a database stored on the database storage device.

8. A system as set forth in claim 4 wherein the document preparation apparatus is configured to provide searchable indicia which includes information that identifies the person with whom the electronic folder is associated and indicia relating to the content of the electronic text file, the content of the electronic image file, and the content of the electronic document file contained in the electronic folder.

9. A system as set forth in claim 4 wherein the document intake apparatus comprises a general purpose computer that is programmed to display the electronic form to a user and which includes means for entering text into the electronic form.

10. A system as set forth in claim 4 wherein the document intake apparatus comprises a kiosk or a dedicated terminal that displays the electronic form to a user and which includes means for entering text into the electronic form.

11. A system for capturing and managing personal documents and information comprising:
an information intake apparatus configured for (i) displaying an information form, (ii) permitting a person to input requested information in the form of text into the displayed form, and (iii) providing the information as an electronic text file;
an imaging device for capturing an image that is characteristic of the person and providing said image as an electronic image file;
a hard document input device that is configured for scanning a printed document and converting it to an electronic document file;
a document preparation apparatus operatively connected to said information intake apparatus, said imaging device, and said hard document input device for (i) receiving the electronic text file, the electronic image file, and the electronic document file, (ii) providing an electronic folder containing the electronic data file, the electronic image file, and the electronic document file, and (iii) providing searchable indicia associated with the electronic folder; and
a document management apparatus configured for creating the information form and for modifying an existing information form.

12. A system as set forth in claim 11 comprising a storage device operatively connected to said document preparation apparatus for receiving and storing the electronic folder.

13. A system as set forth in claim 11 comprising a database storage device operatively connected to said document preparation apparatus for receiving the searchable indicia associated with the electronic folder and storing the searchable indicia in a database stored on the database storage device.

14. A system as set forth in claim 12 comprising a database storage device operatively connected to said document preparation apparatus for receiving the searchable indicia associated with the electronic folder and storing the searchable indicia in a database stored on the database storage device.

15. A system as set forth in claim 11 wherein the document preparation apparatus is configured to provide searchable indicia which includes information that identifies the person with whom the electronic folder is associated and indicia relating to the content of the electronic text file, the content of the electronic image file, and the content of the electronic document file contained in the electronic folder.

16. A system as set forth in claim 11 wherein the document intake apparatus comprises a general purpose computer that is programmed to display the electronic form to a user and which includes means for entering text into the electronic form.

17. A system as set forth in claim 11 wherein the document intake apparatus comprises a kiosk or a dedicated terminal that displays the electronic form to a user and which includes means for entering text into the electronic form.

18. A method of capturing and managing personal documents and information comprising the steps of:
capturing information from a person on an information intake apparatus;
providing an electronic text file containing said information;
capturing an image that is characteristic of the person and providing said image as an electronic image file;
providing an electronic image file containing said image;
scanning a printed document and converting it to an electronic document file;
receiving the electronic data file, the electronic image file, and the electronic document file in a document preparation apparatus;
providing an electronic folder containing the electronic text file, the electronic image file, and the electronic document file; and
providing searchable indicia associated with the electronic folder for identifying and retrieving the electronic folder.

19. The method according to claim 18 wherein the step of capturing the information comprises the steps of:
displaying the electronic information form; and
permitting the person to enter requested information into the displayed electronic form.

20. The method according to claim 18 comprising the steps of:
storing the electronic folder on an electronic storage device; and
storing the searchable indicia on the electronic storage device.

21. The method according to claim 18 comprising the step of providing an encrypted signature associated with the electronic folder for verifying the authenticity of the electronic text file, the electronic image, and the electronic document file in the electronic folder.
